(19) United States
(12) Patent Application Publication
(10) Pub. No.: US 2009/0048864 A1
(43) Pub. Date: Feb. 19, 2009

(54) METHOD AND APPARATUS FOR THERAPEUTIC INTERCHANGE

(75) Inventors: Casey L. Kozlowski, Barrington, IL (US); Gowri Selka, Buffalo Grove, IL (US); Sam Libo, Deerfield, IL (US); Natasha Polster, Long Grove, IL (US)

Correspondence Address: FRANCIS C. KOWALIK;WALGREEN CO. LAW DEPARTMENT, 104 WILMOT ROAD, M.S. #1425, DEERFIELD, IL, 60015, US

(73) Assignee: WALGREEN CO., Deerfield, IL (US)

(21) Appl. No.: 11/839,433

(22) Filed: Aug. 15, 2007

(51) Int. Cl. G06Q 50/00

(52) U.S. Cl. 705/2

(57) ABSTRACT

A method and apparatus of interchanging a prescribed medication with a therapeutically equivalent replacement medication includes receiving medication prescription data relating to a medication prescription for a person identifying a therapeutically equivalent replacement medication for a medication associated with the medication prescription, generating an exception for the medication if a replacement medication is identified so as to prevent the medication from being dispensed to the person until the exception is resolved, transmitting a request to replace the prescribed medication with the therapeutically equivalent replacement medication to a medical provider, and resolving the exception based on the response from the medical provider.

### TECHNICAL FIELD

The present disclosure relates generally to medication therapy management, and, more specifically, to replacing a prescribed medication with a therapeutically equivalent medication.

### BACKGROUND

Many medications have alternative medications that are therapeutically equivalent. That is, from a clinical perspective, an alternative medication has the same medical effect, or even a more advantageous medical effect, as compared to that of the original medication. Even if the medical effect is considered clinically equivalent, the alternative medication may have additional advantages, such as reduced side effects, increase efficiency when combined with other medications, increased strength resulting in lower dosages, lower costs and other advantages that still cause the alternative medication to be considered more efficient than the original medication.

However, a person who has been prescribed a medication may generally be unaware of the availability of alternative medications that are considered therapeutically equivalent to the prescribed medication. On the other hand, a pharmaceutical professional, such as a pharmacist, may be in a particularly good position to be aware of therapeutically equivalent medications. In particular, the pharmaceutical professional may be able to advise and consult the person as to alternatives, as well as any advantages associated therewith (e.g., improved medical effect, lower cost, etc.). Accordingly, the person may be provided with an opportunity to replace the prescribed medication with a therapeutically equivalent medication.

Nonetheless, the number of medications that may be prescribed are voluminous. Although medical providers and pharmaceutical professionals are in opportune positions to know of therapeutically equivalent medications, it is virtually impossible for any one medical provider or pharmaceutical profession to have knowledge of some or all replacement medications for some or all of the available medications. Accordingly, it would be beneficial to be able to define therapeutically equivalent medications for a variety of medications and maintain information about the medications and their therapeutic equivalents, such that the information may be readily accessed by those in a position to offer the therapeutically equivalent medication. Still further, it would be beneficial to alert those in a position to offer the therapeutically equivalent medication that such a replacement medication is available and to offer the person the opportunity to replace the prescribed medication with the replacement medication, for example when the person is filling or refilling the medication prescription.

Even if a therapeutically equivalent medication is available for a prescribed medication and a person, such as pharmaceutical professional, is in a position to be alerted to the replacement opportunity and counsel the person regarding the same, the person's medical provider and/or one who prescribed the medication being replaced should still be notified of the proposed interchange. In particular, the person's medical provider may be in the best position to know whether or not the person should be prescribed the replacement medication based on a better understanding of the person's medical history. Accordingly, it would be beneficial to be able to alert the person's medical provider about the interchange opportunity and allow the medial provider to have input as to the interchange.

Further, particular groups of people, such as though taking a particular medication therapy regimen or those under a particular medical insurance plan, may be prevented from being offered the replacement medication for a variety of reasons, including interaction with other medications in the medication therapy regimen, lack of coverage or increase in co-pays from the medical insurance plan etc. In other cases, third party formularies, such as formularies developed for an insurance plan, may identify a different replacement medication which may be offered to persons belonging to a particular group (e.g., those covered by the insurance plan). As such, it may be beneficial to define the replacement medication identified using a third party formulary as a replacement medication for that group of persons, whereas the originally identified replacement medication may be offered to those persons not in the group. It may also be beneficial to otherwise tailor the replacement medications and the availability of the replacement medications according to a person's participation in particular groups.

### BRIEF DESCRIPTION OF THE DRAWINGS

FIG. 1 is a block diagram of an embodiment of an intelligent network system for defining and providing therapeutically equivalent replacement medications for prescribed medications;

FIG. 2 is a flowchart of an embodiment of a medication therapy regimen optimization routine to determine opportunities to optimize the medication therapy regimen by replacing a prescribed medication with a therapeutically equivalent replacement medication;

FIG. 3 is an exemplary graphical display that may be provided by a graphical user interface to enable a user to initiate an editor application to define replacement medications for a medication;

FIG. 4 is an exemplary graphical display that may be provided by a graphical user interface to enable a user to define a therapeutically equivalent replacement medication for a selected medication;

FIG. 5 is an exemplary graphical display that may be provided by a graphical user interface to enable a user to provide the user with clinical information relating to proposed replacement medications and to select one of the proposed replacement medications as the therapeutically equivalent replacement mediation.

FIG. 6 is an exemplary graphical display that may be provided by a graphical user interface to enable a user to define groups of people that will be excluded from being offered the therapeutically equivalent replacement medication;

FIG. 7 is an exemplary graphical display that may be provided by a graphical user interface to enable a user to identify and track information pertaining to a group of people;

FIG. 8 is an exemplary graphical display that may be provided by a graphical user interface to enable a user to view information pertaining to therapeutically equivalent replacement medications identified using an alternative formulary;

FIG. 9 is an exemplary graphical display that may be provided by a graphical user interface to enable a user to identify a therapeutically equivalent replacement medication for a particular group of persons;

FIG. 10 is an exemplary graphical display that may be provided by a graphical user interface to enable a user to view medication prescription information;

FIG. 11 is an exemplary graphical display that may be provided by a graphical user interface to prompt a user that a therapeutically equivalent replacement medication is available and may be exchanged with the prescribed medication;

FIG. 12 is an exemplary graphical display that may be provided by a graphical user interface to enable a user to view exceptions relating to the medication prescription, including an exception generated in response to the availability of a therapeutically equivalent replacement medication;

FIG. 13 is an exemplary graphical display that may be provided by a graphical user interface to enable a user to reject the therapeutically equivalent replacement medication and resolve the exception;

FIG. 14 is an exemplary graphical display that may be provided by a graphical user interface to enable a user perform the exchange of the prescribed medication for the therapeutically equivalent replacement medication;

FIG. 15 is an exemplary graphical display that may be provided by a graphical user interface to enable a user view information pertaining to the prescribed medication and the therapeutically equivalent replacement medication;

FIG. 16 is an exemplary graphical display that may be provided by a graphical user interface to enable a user to view and edit a proposed medication prescription for the therapeutically equivalent replacement medication and to prompt the user as to a cost comparison of the therapeutically equivalent replacement medication and the prescribed medication;

FIG. 17 is an exemplary graphical display that may be provided by a graphical user interface to enable a user to accept the therapeutically equivalent replacement medication and resolve the exception based on a medical provider's response to a request to replace the prescribed medication with the therapeutically equivalent replacement medication;

FIG. 18 is an exemplary graphical display that may be provided by a graphical user interface to enable a user to reject the therapeutically equivalent replacement medication and resolve the exception based on a medical provider's response to a request to replace the prescribed medication with the therapeutically equivalent replacement medication; and

FIG. 19 is an exemplary graphical display that may be provided by a graphical user interface to enable a user to reverse a previously executed replacement of the prescribed medication with the therapeutically equivalent replacement medication.

### DETAILED DESCRIPTION

It should be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

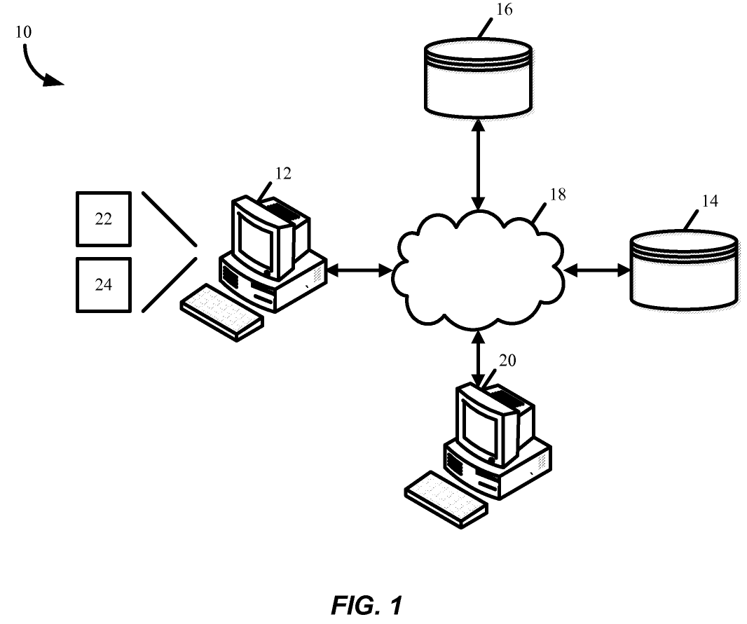

FIG. 1 is an exemplary schematic block diagram of an example of a data network and system 10 for providing therapeutic interchanges to replace an existing medication in a person's medication prescription with another medication that is considered more efficient, whether in terms of lower cost, reduced side effects, improved medical effect, improved medical effect in combination with other medications, etc. Referring to FIG. 1, the data network 10 may include a workstation 12 and a plurality of data sources 14, 16 communicatively coupled to the workstation 12. Although only one workstation 12 is depicted, it should be understood that the system 10 may include many workstations 12 at the same geographic location (e.g., the same pharmaceutical facility) and/or different geographic locations (e.g., different pharmaceutical facilities). Likewise, although only two data sources 14, 16 are depicted, it should be understood that the system 10 may include many data sources 14, 16 communicatively coupled to the workstation 12 via a network 18.

In one example, one of the data sources 14 may be provided as a data source that stores data relating to medication prescriptions, and the other data source 16 may be provided as a data source that stores data relating to replacement medications. Each of the data sources 14, 16 may be a centralized data source for multiple workstations 12 and/or a local data source of a particular workstation which is accessible by other remote workstations 12. The workstation 12 may be a personal computer, a network terminal or the like provided at a pharmaceutical facility, such as a pharmaceutical care center or a pharmaceutical store. The data source 14 may include databases or other memory systems that store medication prescription data for each of a plurality of persons. Likewise, the data source 16 may include databases or other memory systems that store replacement medication data for each of a plurality of medications. Although shown as being coupled via the network 18, each of the data sources 14, 16 may be provided as an internal database of the workstation 12, including, but not limited to, a hard drive, a random access memory, a read-only memory or a removable storage device such as an optical disk, a magnetic disk, a flash memory card, an external hard drive, a zip drive, etc. Alternatively, the data sources 14, 16 may be provided as an external database, such as a network server or external hard drive.

Each of the workstation 12 and the data sources 14, 16 are inter-operatively coupled via a network 18, which may comprise, for example, the Internet, a wide area network (WAN), a local area network (LAN) or a mesh network. The network 18 may be provided using a wide variety of techniques well known to those skilled in the art for the transfer of electronic data. For example, the network 18 may comprise dedicated access lines, plain, ordinary telephone lines, satellite links, combinations of these, etc. Additionally, the network 18 may include a plurality of network computers or server computers (not shown), each of which may be operatively interconnected in a known manner. Where the network 18 comprises the Internet, data communication may take place over the network 18 via an Internet communication protocol.

As further shown in FIG. 1, the data network 10 may further include a medical provider workstation 20, generally provided at a different geographic location than that of the workstation 12, such as a medical provider's office or facility. The medical provider generally includes an entity who is authorized to prescribe medications, which may include home care providers, hospitals, clinics and doctors. As such, a workstation 12 at a pharmaceutical facility and the user thereof, may be communicatively coupled to the medical provider workstation 20 and a user thereof (e.g., the medical provider). As with the workstation 12, the medical provider workstation may be provided as a personal computer, a network terminal or the like provided at a medical provider's facility, such as a office, hospital, care center, etc. As shown in FIG. 1, the workstation 12 and the medical provider workstation 20 are communicatively coupled via the network 18. However, it should be understood that the workstation 12 and the medical provider workstation 20 may be communicatively coupled via a different network. For example, whereas the network 18 may be a WAN or LAN, the communication network between the workstation 12 and the medical provider workstation 20 may be a telephone network, Internet, or other public use communication network. Further, while the workstation 12 may have access to the data stored in the data sources 14, 16, the medical provider workstation 20 may be prevented from accessing the data sources 14, 16, despite being on the same network 18. Although only one medical provider workstation 20 is depicted it should be understood that the system 10 may include many medical provider workstations 20 at the same geographic location (e.g., the same medical provider facility) and/or different geographic locations (e.g., different medical provider facilities).

Likewise, although the data network 10 is shown to include one workstation 12, one data source 14 for the medication prescription data, and one data source 16 for the replacement medication data, it should be understood that different numbers of workstations, and data sources may be utilized. For example, the data network 10 may include a plurality of workstations 12, data sources 14, and data sources 16, all of which may be interconnected via the network 18. According to the disclosed example, this configuration may provide several advantages, such as, for example, enabling near real time uploads and downloads of information, as well as periodic uploads and downloads of information, if desired.

The data source 14 may store medication prescription data for persons, such as patients and prescription consumers, that fill their prescriptions at the pharmaceutical facility where the workstation 12 is located. Medication prescription data may include, but is not limited to, data related to identification of the person, data related to a medication being prescribed to the person, and data related to consultation information to be conveyed to the person. The identification data of the person may include details such as the person's name, address, phone number, birth date, social security number, insurance company provider, insurance policy identification, or any other information pertaining to the person. The medication data may include details about the medication being prescribed to the person, such as prescription number, medication name, medication description, prescribing doctor, prescription fill/refill dates, patient name, storage instructions, usage instructions or any other details regarding the medication. Although discussed in greater detail below, consultation information may include usage instructions for taking the medication in addition to those provided with the medication data, medication purpose, actual or potential side effects, emergency instructions, and further in information and/or instructions as may be associated with the medication. Consultation information may further include personal comments, remarks or observations by a pharmaceutical professional, such as a pharmacist and consultation instructions for the pharmaceutical professional providing the consultation. Still further, the consultation information may include message or alert information, such as an identified adverse health outcome associated with utilization of the medication, a replacement medication, availability of a generic medication, or fill/refill alerts. Of course, it should be understood that the particulars about the consultation information are not limited to the examples provided, but may relate to additional information that may be useful in consulting, a person about a medication prescription.

The data source 16 may store replacement medication data for various medications. In particular, each medication may be evaluated to determine if a replacement medication exists, and data relating to the medication may be stored along with data relating to replacement medications that have been identified as being appropriate alternatives to the medication. The data on the medications and the associated replacement medications are stored in the data source 16 as replacement medication data. Replacement medications may be chosen based on third-party plan formularies, based on generic availability within particular medication classes or based on clinical equivalence. By comparison, the replacement medication may have an equivalent or improved medical effect to the existing medication but with reduced or no side effects, lower cost, a combined medical effect of two or more medications, or an improved overall medical effect when combined with other medications in the medication therapy regimen. An example of identifying replacement medications and providing replacement medication data to the data source 16 is provided further below.

It should be understood that each of the workstations 12 and data sources 14, 16 may be coupled to the data network 10 by a network computer which may include a processor, a memory operatively coupled to the processor and/or a database operatively coupled to the processor and memory. In some instances, each workstation 12 and data source 14, 16 may maintain its own internal data network, such that the workstation 12 may be one of a plurality of workstations at a pharmaceutical facility, the data source 14 may be one of a plurality of databases or servers such as an array databases or servers, and the data source 16 may be one of a plurality of databases or servers such as an array of databases or servers. Alternatively, while the data sources 14, 16 are shown as being provided as separate, it should be understood that the data sources 14, 16 may share resources, such as the same data base, hard drive, memory, or removable storage device. The network computer may be a server computer of the type commonly employed in networking solutions.

The workstation 12 may include a therapeutic interchange editor application 22 stored on a memory of the workstation 12, or the workstation 12 may otherwise access the editor application 22 stored on another memory device or other computer readable medium. The editor application 22 provides a workflow process for users to identify and track various aspects related to performing a therapeutic interchange to replace an existing medication of a medication prescription with a replacement medication. Using the editor application 22, replacement medications may be identified or otherwise defined and stored as replacement medication data in the data source 14. Although shown as being executed on the workstation 12, the editor application 22 may be executed on another workstation, which may be provided separate and secure from users of the workstation 12 in order to prevent unauthorized access and manipulation of replacement medication data.

The workstation 12 may further include a therapeutic interchange application 24 stored on a memory of the workstation 12, or the workstation 12 may otherwise access the therapeutic interchange application 24 stored on another memory device or other computer readable medium. For example, the therapeutic interchange application 24 may be provided centrally, and accessed by the workstation 12.

The therapeutic interchange application 24 facilitates identification of a replacement medication and alerts a user of the workstation 12 when a medication prescription is being filled for a person. In particular, as a medication prescription is being filled for the person, for example after the medication prescription data is being entered or reviewed by the user at the pharmaceutical facility when the person is in the process of filling the prescription, interchange opportunities to replace the existing medication of the medication prescription with a replacement medication may be checked using the therapeutic interchange application 24. As the user proceeds to fill the medication prescription, for example by proceeding to complete a transaction for the medication, the therapeutic interchange application 24 may search the data source 16 for any replacement medications associated with the medication being filled. If a replacement medication exists, the user may be alerted that a replacement is available. The therapeutic interchange application 24 allows the user to review the replacement medication as compared to the existing medication, and obtain approval from the medication provider to change the medication prescription or substitute the existing medication prescription for a medication prescription for the replacement medication. The interchange application 24 further allows a user to replace the medication or maintain the original application based on the approval or denial from the medical provider, as well as afford an opportunity to the person to accept or deny the replacement medication or reverse a previous mediation interchange. Still further, the therapeutic interchange application 24 allows the user to update the medication prescription data in the data source 14 if the medication is replaced. However, it should be understood that the order in which the therapeutic interchange application 24 is executed may vary. For example, if the user is alerted that a replacement is available, the therapeutic interchange application 24 may first allow the user to obtain approval from the person to change the medication prescription or substitute the existing medication prescription for a medication prescription for the replacement medication. Approval from the person may be followed by generating a new medication prescription for the replacement medication and obtaining approval from the medication provider for the changed or substituted medication.

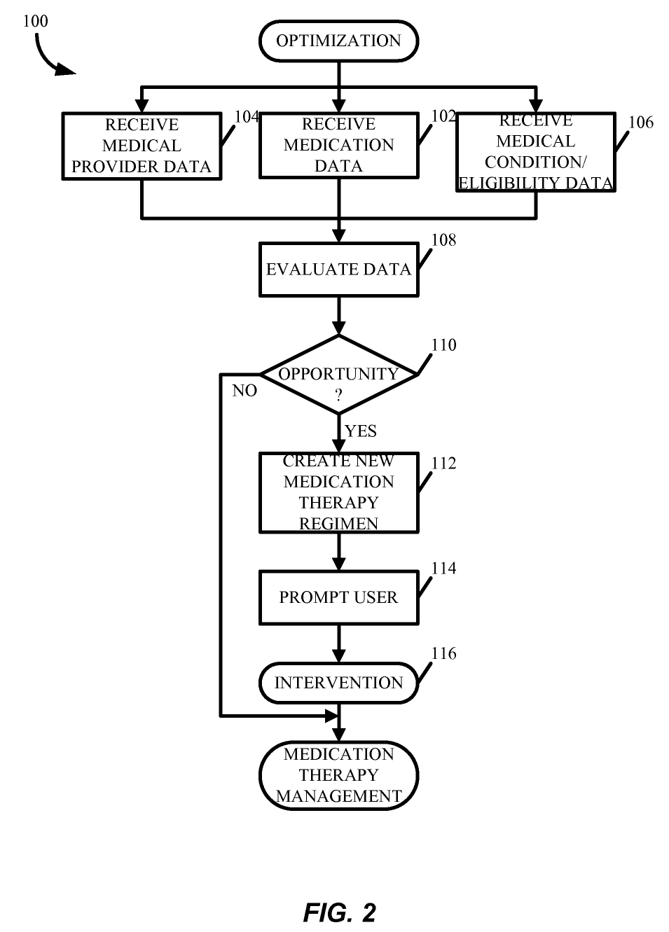

An example for evaluating and identifying replacement medications are described in copending U.S. patent application Ser. No. 11/458,059 entitled “Optimization Of A Medication Therapy Regimen” filed on Jul. 17, 2006, the contents of which are incorporated by reference herein in their entirety for all purposes. In particular, FIG. 2 illustrates an example of a medication therapy regimen optimization routine 100 which may be executed by the editor application 22 and therapeutic interchange application 24 shown schematically in FIG. 1. The medication therapy regimen optimization routine 100 may be used to optimize a person's medication therapy regimen by analyzing the medication therapy regimen, and particularly the medications of the person's medication prescription(s), identifying opportunities for optimization and modifying the medication therapy regimen (e.g., modifying or substituting a medication prescription for a replacement medication). The medication therapy regimen optimization routine 100 is particularly useful for those persons, such as elderly patients, having multiple medications, multiple medical conditions and/or multiple medical providers.

Beginning at block 102, the medication therapy regimen optimization routine 100 receives medication data relating to one or more medications being used by the person. Examples of the medication data that may be utilized by the medication therapy regimen optimization routine 100 include, but are not limited to, the name of the medication, medical effect potential side effects, potential interactions with other medications, reasons for the medication such as medical conditions the medication is meant to address (e.g., a valid indication), the person's duration of use and the person's utilization of a medication such as a rate or amount of use, rate or amount of refills, medication dosage, cost, instructions for administering the medication, medication strength, etc.

Optionally, at block 104, the routine 100 may receive medical provider data relating to one or more medical providers associated with the person, including doctors, hospitals, clinics and home care services which may provide the person with medical examinations, medical treatment and/or prescribe medications, and at block 106, the routine 100 may receive medical condition data relating to one or more medical conditions such as drug inferred diseased states, medical claims data and/or medical history or diagnoses associated with the person. In addition to receiving medical condition data at block 106, the routine 100 may receive eligibility data to verify or determine whether the person is eligible for the service.

Generally, the data received at blocks 102, 104, 106 may be received by retrieving medication prescription data from the data source 14. Alternatively or in addition, some or all of the data received at blocks 102, 104, 106 may be received from an employer/healthcare insurer, medical provider and/or another pharmaceutical store.

At block 108, the medication therapy regimen optimization routine 100 evaluates the medication data, and may further evaluate the medical provider data and/or the medical condition data, for potential opportunities for optimization, including therapeutic interchange. The evaluation at block 108 may initially include evaluating the person's data for specific criteria to identify and stratify those persons having, but not limited to, multiple medical providers, multiple medications and/or multiple medical conditions, In one example, the evaluation conducted by the routine 100 may include predictive modeling such as determining potential interactions between various medications being used by the person, and interactions between a medication and a medical condition. The evaluation at block 108 may also identify instances of over-utilization or underutilization, identify medications which may no longer be required, are duplicative or otherwise redundant. Potentially adverse health outcomes may be identified, including side effects, hazardous interactions, For each identified, potentially adverse health outcome, the severity of the adverse health outcome may be determined.

Still further, the evaluation at block 108 may evaluate the cost associated with the person's medication therapy regimen, including the cost of each medication individually and the total cost of the medication therapy regimen. For example, the evaluation may be used to identify whether the person has a total medication therapy regimen cost of over $4000 per year, or any other threshold amount including the overall cost of the medications to the person taking into account insurance coverage and co-pays. Although the evaluation may be conducted in all or in pan by a software routine, in some instances the evaluation requires the expertise of a pharmaceutical professional such as a pharmacist. As such, all or part of the evaluation may be conducted by a pharmaceutical professional, such as a pharmacist at the pharmaceutical facility. The result from the evaluation of the medication therapy regimen may include a Personal Medication Record, which includes a list of the medications included in the medication therapy regimen and an explanation of the effects and any potential areas where the regimen may be optimized or otherwise improved. Ultimately, the Personal Medication Record is preferably shared with the person to further the person's understanding of the medication therapy regimen.

The evaluation at block 108 may also be based upon treatment guidelines, or other industry recognized standards, for one or more of the medical conditions identified from the medical condition data. In one example, the industry-recognized Medication Appropriateness Index may be used for evaluation. In a further example, the treatment guidelines are established by quality watch group such as a professional organization of pharmacists, medical providers and/or healthcare insurers. Alternatively or in conjunction, the treatment guidelines may be established based on an established medical board, and/or among the participants of the medication therapy regimen management service, examples of which were provided above. Examples of national treatment guidelines for treating particular medical conditions include:
The Seventh Report of the Joint National Committee on Prevention, Detection, Evaluation, and Treatment of High Blood Pressure: The JNC 7 Report. JAMA. 2003; 289 (19): 2560-71.
The third report of the National Cholesterol Education Program (NCEP) Expert Panel on Detection, Evaluation, and Treatment of High Blood Cholesterol in Adults (Adult Treatment Panel III) Executive Summary. National Cholesterol Education Program. National heart, Lung, and Blood Institute. National Institutes of Health. NIH Publication No. 01-3670. May 2001.
National Heart, Lung, Blood Institute. National Asthma Education and Prevention Expert Panel Report 2. Guidelines for the Diagnosis and Management of Asthma. Update on Selected Topics 2002. NIH Publication No. 02-5074. June 2003.
ACC/AHA Guidelines for the Evaluation and Management of Chronic Heart Failure in the Adult, J Am Coll Cardiol 2001; 38: 2101-13.
Global Strategy for the Diagnosis, Management, and Prevention of Chronic Obstructive Pulmonary Disease. GOLD Expert Panel: The Global Initiative for Chronic Obstructive Lung Disease (GOLD) Workshop Report. Updated 2005 (Based on an April 1998 NHLBI/WHO Workshop).
Beta-Blocker Heart Attack Trial Research Group. JAMA. 1982; 247:1707-1714. AND Norwegian Mulitcentre Study Group, N Engl J Med. 1981:304:801-807
U.S. Department of Health and Human Services. Bone Health and Osteoporosis: A Report of the Surgeon General. Rockville, Md.: U.S. Department of Health and Human Services, Office of the Surgeon General, 2004.
Gudbjornsson B, Juliusson U I, Gudjonsson F V. Prevalence of long-term steroid treatment and the frequency of decision making to prevent steroid-induced osteoporosis in daily clinical practice. Ann Rheum Dis 2002; 61(1): 32-36.

Although the examples of the national treatment guidelines provided above include examples of various medical conditions and various sources of treatment guidelines, the medical conditions are not limited thereto. Further, the sources of the national treatment guidelines are not limited to the examples above, and different sources of treatment guidelines may be provided for any of the medical conditions mentioned above or in addition to those medical conditions mentioned above.

The treatment guidelines data may include, but are not limited to, medications for particular medical conditions, medication strengths, instructions for administering the medications, medical treatment for particular medical conditions, and tests or examinations generally administered for the medical condition. The treatment guidelines are provided as inputs to the routine 100 and are the basis for any recommended changes resulting from the routine 100. The treatment guidelines may be updated on a periodic basis to maintain adherence to the most up-to-date standards of health care.

Based on the evaluation at block 108, the medication therapy regimen optimization routine 100 determines whether or not opportunities exist to optimize or otherwise improve the person's medication therapy regimen at block 110 by replacing a medication in one or more of the person's medication, prescriptions. If not, control may revert back to the medication therapy management routine 100. However, if one or more opportunities exist to optimize the medication therapy regimen, the routine 100 may determine a new medication therapy regimen at block 112, for example by preparing a new medication prescription for approval by a medical provider, such as the person's doctor. In some instance, creation of a new medication therapy regimen may include modifying the person's existing medication therapy regimen.

The creation of a new medication regimen at block 112 may include removing and/or replacing one or more medications with a new medication. For example, a medication may be removed if it is duplicative of another medication, if the medication is no longer required (e.g., the associated medical condition no longer exists), if the removal of the medication will improve the medical effect of the other medications without adversely affecting the person, if the removal will reduce or eliminate an undesired side effect or if the medication was without indication. A medication may be replaced with another medication, including replacing a brand name medication with a lower cost or equivalent generic medication, if available.

In addition to creating a new medication therapy regimen for the person, the routine 100 may further evaluate the new medication therapy regimen to identify any potentially adverse health outcomes, the risk associated with the identified, potentially adverse health outcome, the likelihood of such outcomes, or otherwise evaluate the new medication therapy regimen in a manner similar to the evaluation of the existing medication therapy regimen as was performed at block 108. In one example, the routine 100 may cause a request to be issued to the medical provider to approve or deny the new medication regimen for example by providing data on an existing medication and data on a replacement medication along with any identified advantages (e.g., reduced side effects, lower cost, etc.).

At block 114, the routine 100 prompts the user to intervene in the person's medication therapy regimen to execute the new medication therapy regimen. The intervention may be conducted in accordance with an intervention routine 116, an example of which is described in further detail in U.S. patent application Ser. No. 11/458,059 referenced above. The intervention may be provided in the form of a consultation with the person, which may be conducted in accordance with a consultation routine, an example of which is described in further detail in copending U.S. patent application Ser. No. 11/839,306 entitled “Method and Apparatus for Medication Prescription Consultation” filed on Aug. 15, 2007, the contents of which are incorporated by reference herein in their entirety for all purposes.

Although an example of an optimization routine 100 has been described above for evaluating a person's medication regimen in order to identify opportunities to optimize the medication regimen, including identifying any potential replacement medications, it should be understood that different routines for identifying opportunities to replace a medication with a more advantageous medication may be utilized. For example, in filling a medication prescription for a person and completing a transaction for the medication, a search of the data source 16 may be conducted to search for the medication associated with the medication prescription, where the editor application 22 is utilized to provide data on one or more replacement medications for each of a number of medications. The therapeutic interchange application 24 is used to perform the search of the data source 16 (or request data associated with the medication from the data source 16), and upon finding or retrieving a data record for the medication, the therapeutic interchange application 24 may be used to facilitate an exchange of the existing medication for an identified replacement medication, as indicated above and described in further detail below.

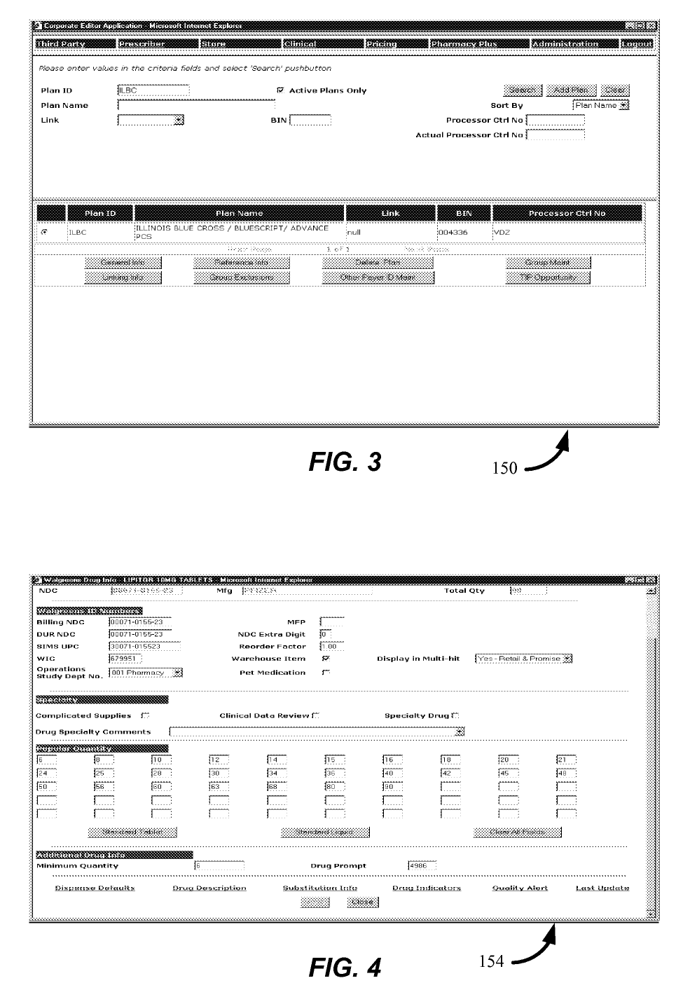

One important aspect of the systems of FIG. 1 is a user interface routine associated with the editor application 22 and the therapeutic interchange application 24, and which provides a graphical user interface (GUI) that is integrated with the editor application 22 and the therapeutic interchange application 24 described herein to facilitate identification of suitable replacements for a medication and facilitating replacement of a medication for a person's medication prescription. FIGS. 3-19 provide exemplary displays of the GUI that may be generated by the editor application 22 and the therapeutic interchange application 24 in order to facilitate identification of replacement medications and replace a medication of a person's medication prescription. However, before discussing the GUI in greater detail, it should be recognized that the GUI may include one or more software routines that are implemented using any suitable programming languages and techniques. Further, the software routines making up the GUI may be stored and processed within a single processing station or unit, such as, for example, a workstation 12 within a pharmaceutical facility or, alternatively, the software routines of the GUI may be stored and executed in a distributed manner using a plurality of processing units that are communicatively coupled to each other within the system 10.

Preferably, but not necessarily, the GUI may be implemented using a familiar graphical windows-based structure and appearance, in which a plurality of interlinked graphical views or pages include one or more pull-down menus, buttons or other graphical representations that enable a user to navigate through the pages in a desired manner to view and/or retrieve particular types of information regarding the medication prescription. The features and/or capabilities of the consultation application may be represented, accessed, invoked, etc. through one or more corresponding pages, views or displays of the GUI. Furthermore, the various displays making up the GUI may be interlinked in a logical manner to facilitate a user's quick and intuitive navigator through the displays to retrieve a particular type of information or to access and/or invoke a particular capability of the editor application 22 and the therapeutic interchange application 24.

Generally speaking, the GUI described herein provides intuitive graphical depictions or displays to search and provide information relating to the medication prescription of the person. Each of these graphical displays may include particular medication prescription information that is associated with a particular view being displayed by the GUI. For example, a display for searching for a person's medication and medication prescription may be provided, with medication prescriptions resulting from the search displayed for the user to select in order to display further information about the selected medication prescription and conduct a search for replacement medications. On the other hand, a display depicting a medication interchange may provide information to generate a medication prescription for a replacement medication, which is conveyed to a medical provider with data on the original medication. In any event, a user may use the information shown within any view, page or display to quickly access information about the medication prescription, the replacement medication and convey appropriate information to the medical provider and the person.

Additionally, the GUI described herein may automatically, or may in response to a request by a user, provide a display depicting an exception queue having a table of exceptions associated with the person's meditation prescription, including an exception that may be generated in response to identifying a replacement medication and temporarily preventing the transaction for the original medication or the replacement medication from being completed until the exception is resolved. The exception information may be provided by the data source 14. Similarly, the GUI may display alerts and messages regarding a replacement medication or availability of a generic medication. These messages may include graphical and/or textual information that describes the potential replacement, describes courses of action that may be pursued to correct or to avoid a problem, identifies advantages associated with the replacement, etc.

The editor application 22 and the therapeutic interchange application 24 may therefore include the graphical user interface and the features described herein. Generally, the editor application GUI and the therapeutic interchange application GUI may be presented as a series of windows or display screens having one or more views each for various types of information. Each time a user logs into the workstation to fill a medication prescription, the user begins a new session of the therapeutic interchange application 24.

FIGS. 3-9 are exemplary graphical displays that may be provided by the GUI to enable a user at a workstation 12, such as a pharmacist or another qualified pharmaceutical professional, to define and maintain data on available medications and replacement medications for each medication. In particular, the graphical displays of FIGS. 3-9 may be utilized with respect to the editor application 22, though it should be readily understood that similar graphical displays may be used with respect to the editor application 22. Generally, the replacement medication associated with a medication may be considered a therapeutic equivalent, or medical effect, to the medication. In some cases, the replacement medication may have improvements or advantages over the medication, such as an improved medical effect, a reduced side effect, a reduced side effect when in combination with other medications, lower cost, reduced risk of adverse health risks, reduced dosage, generics, etc. However, for purposes of defining and maintaining data on replacement medications, all replacement medications that are considered therapeutic equivalents may be maintained as replacement medications regardless of any advantages, such as those mentioned above, over the existing medication. For each medication, a replacement medication may be identified as a default replacement medication. In addition, replacement medications may be identified as an alternative customized for a particular person or group of people, based on a medical insurance plan, a medical regimen, etc. Using the editor application 22 and the display screens shown in FIGS. 3-9, a user may not only identity replacement medications that are therapeutically equivalent to a given medication, but may also tailor the replacement medications according to third-party formularies, restrict groups of people from being offered replacement medications for a particular medication or restrict groups of people from being offered replacement medications in general. Each of the replacement medications identified for a medication, and the options related thereto (e.g., exclusions, third-party formularies, etc.) may be saved as replacement medication data in the data source 16.

FIG. 3 illustrates an example screen display 150 that may be presented to a user to initiate the editor application 22 in order to define replacement medications for a particular medication, and maintain the medication and its replacements as medication replacement data in the data source 16. In particular, the display 150 includes several graphical representations, each of which may represent a different application within a suite of applications that may be provided to the user by the editor application 22. For example, a series of graphical representations presented as tabs at the top of the display 150 may each relate to a different aspect of the editor application 22, with the graphical representation 152 labeled “Clinical” provided to enable the user to initiate defining replacement medications by selecting the graphical representation “Clinical” using, for example, a keyboard, mouse, voice-response device, etc. Although several examples of graphical representations, such as buttons, data entries, etc., that may be selected by the user are described herein, it should be understood that each such graphical representation may be selected in a variety of manners using, for example, a keyboard, mouse, voice-response device, and the like, and need not be repeated in each instance that a graphical representation is described.

As mentioned above, replacement medications for each medication may be defined as a customized for a particular group of people. In the example provided in FIG. 3, the user may identify, replacement medications for a group of people under the same medical insurance plan. In particular, the display 150 provides several fields from which the user may enter search criteria to search for a particular insurance company or plan (e.g., Plan ID, Plan Name, link, BIN, Active Plans Only, etc.). The editor application may perform a search of all plans to identify those that meet the provided search criteria, the results of which are provided to the user. The editor application 22 enables the user to identify which plan the replacement medications will be defined for by selecting one of the search results. Upon selecting a plan, the user may select the graphical representation “Clinical” 152 to begin defining replacement medications of medications for the group of people that belong to the selected insurance plan. Alternatively, the user may proceed with selecting the graphical representation “Clinical” 152 without selecting a group of people, in which case the user may define replacement medications for all persons.

FIG. 4 illustrates an example screen display 154 that may be presented by the editor application 22 to a user in response to the user selecting the graphical representation 152 from the display 150. In particular, the screen display 154 is provided by the graphical user interface to provide the user with information about a particular medication (e.g., Lipitor) that has been selected for identifying replacement medications as being therapeutically equivalent. The medication information may include various identifications for the medication, quantities, etc., including various graphical representations regarding options that the user may undertake with respect to the medication. For example, the options provided in FIG. 4 include various dispensations options (“Dispense Defaults”), a description of the medication (“Drug Description”), replacement medication options (“Substitution Info”), indicators (“Drug Indicators”), alerts (“Quality Alert”) and updates (“Last Update”).

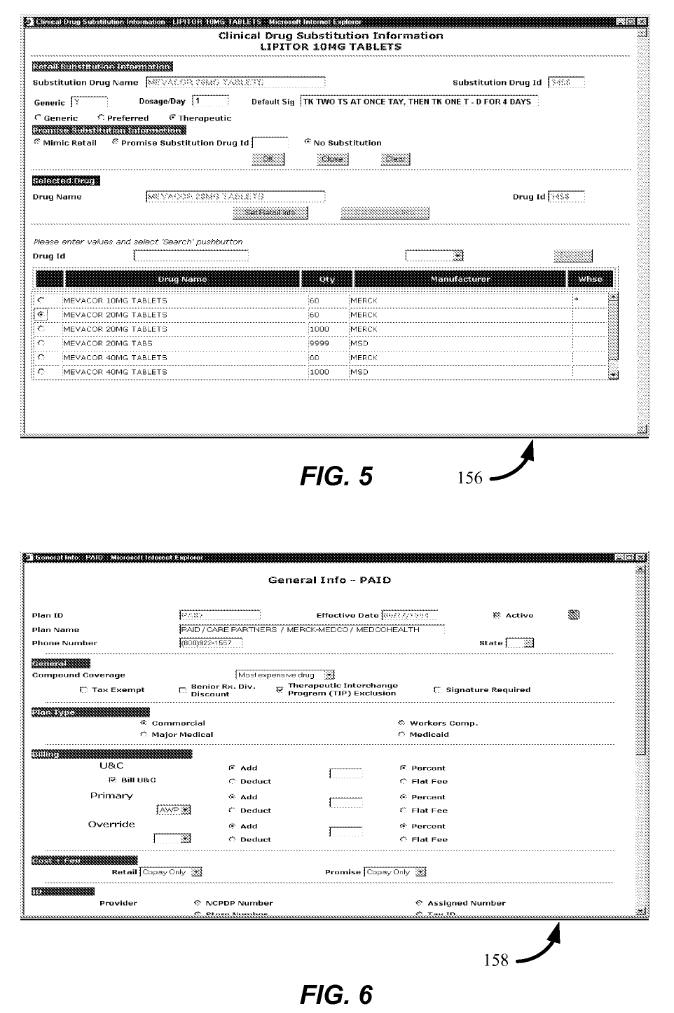

FIG. 5 illustrates an example screen display 156 that may be presented by the editor application 22 to a user in response to the user selecting the graphical representation “Substitution Info” from the display 154. In particular, the screen display 156 is provided by the graphical user interface to provide the user with clinical information relating to the replacement medication. The screen display 156 allows the user to select replacement medications as an alternative to the medication identified in the previous screen display 154. The screen display 156 includes all identified of the medication which was identified from the previous screen display 154 (e.g., Lipitor 10 mg Tablets), and provides several fields from which the user may enter search criteria to search for a particular replacement medication for the medication identified in the previous display screen 154 (e.g., Drug ID). Based on the search criteria entered by the user, the editor application 22 searches for the replacement medication and displays the results, shown in FIG. 5 at the bottom of the display screen, from which the user may select the appropriate replacement medication. As shown in FIG. 5, the search results includes multiple entries for the same replacement medication (e.g., Mevacor 20 mg tablets), where the search results differ based on quantity (e.g., 60, 1000, etc.). As shown in FIG. 5, the search results include multiple results for the same type of medication (e.g., Mevacor) in different strengths (e.g., 10 mg tablets, 20 mg tablets, etc.). It should be understood that while the type of medication (e.g., Mevacor) may be considered an equivalent to another type of medication (e.g., Lipitor), equivalency may be determined based on strength (e.g., 20 mg, of Mevacor versus 10 mg of Lipitor). As such, the strength of a medication may be considered as part of the replacement medication in order to be considered a therapeutic equivalent to the identified medication.

In addition, the screen display 156 includes an identification of the replacement medication being identified as a therapeutic equivalent to the identified medication (e.g., Mevacor 20 mg Tablets) as well as the dosage (Dosage/Day: 1). It should be understood that while a replacement medication is considered an equivalent to another medication, equivalency may be determined based on dosage. As a result, the dosage of a medication may be considered as part of the replacement medication in order to be considered a therapeutic equivalent to the identified medication.

As mentioned above, a replacement medication may be considered a replacement for a variety of reasons. In some cases, the replacement medication may be a generic version of a brand name medication which was selected as the identified medication. In other cases, the replacement medication may be a preferred medication over that of the identified medication, due to a lower cost, preferred brand, etc. In yet other cases, the replacement medication may be a therapeutic alternative to the identified medication, such that the replacement medication has a therapeutic advantage over the identified medication (e.g., reduces side effects, improved medical effects, reduce risk of an adverse health outcome etc.). As such, the replacement medication identified in the screen display 156 may be associated with reasons for its identification as a replacement medication, which may be presented to the user as a series of selectable radio buttons (e.g., Generic, Preferred, Therapeutic).

Once a replacement medication has been identified for the identified medication, the selected replacement medication is considered the default replacement for the identified medication, where more than one replacement medication may exist for the identified medication. In one example, a replacement medication that is identified as a therapeutic equivalent to the identified medication (e.g., by selecting the “Therapeutic” radio button) may be identified by the editor application 22 as a default replacement medication over other replacement medications that may be identified as a generic replacements or preferred replacements. When the data on the replacement medication is saved as replacement medication in the replacement medication data source 16, the selected replacement medication is marked as a therapeutic equivalent medication.

As a feature of the editor application 22, particular groups of persons may be excluded from being offered replacement medication, and, in one example, from being offered replacement medications that are therapeutic equivalents. Groups of persons may be identified based on various criteria, including people on a particular medication regimen or associated with a particular medication plan (e.g., insurance plan). In particular, the groups of persons may be excluded from participating in the therapeutic interchange, such that even though a medication has been identified as a therapeutic equivalent, persons belonging to the group will not be offered the option of replacing their medication with a replacement medication that is a therapeutic equivalent. For example, if a particular medical insurance plan has opted out of participating in offering its insureds therapeutically equivalent replacement medications.

Referring back to FIG. 3, in order to exclude a group of persons, such as members of a third party medical insurance plan, from being offered therapeutically equivalent replacement medications, the user may a series of graphical representations presented as tabs at the top of the display screen 150 may select the graphical representation “Third Party” provided at the top of the display screen 150 as a tab. Selecting the graphical representation “Third Party” enables the user to access the aspect of the editor application 22 to exclude groups of persons. Upon selecting the “Third Party” tab, the editor application 22 generates a display screen 158 shown in FIG. 6 for a group of people identified from the display screen 150. As shown in FIG. 3, the group of persons being excluded are those that are insured under a medical insurance plan (e.g., ILBC), though it should be understood that other groups may be defined according to other criteria (e.g., by medical therapy regimen, medical provider, etc.).

In the display screen 158 of FIG. 6, the user is provided with the option of excluding members of the medical insurance plan from participating in the replacement medications by selecting a checkbox (e.g., Therapeutic Interchange Program (TIP) Exclusion) or otherwise enabling the user with an option to exclude the persons belonging to the identified group from being offered replacement medications. In one example, each person belonging to the excluded group may have their medication prescription data updated in the data source 14 to reflect the exclusion. Alternatively, when filling a prescription for a person belonging to an excluded group, when medication prescription data for the person is read from the data source 14 the therapeutic interchange application 24 may read data relating to groups the person belongs (e.g., reading medical insurance data) and automatically recognize the group as being an excluded group.

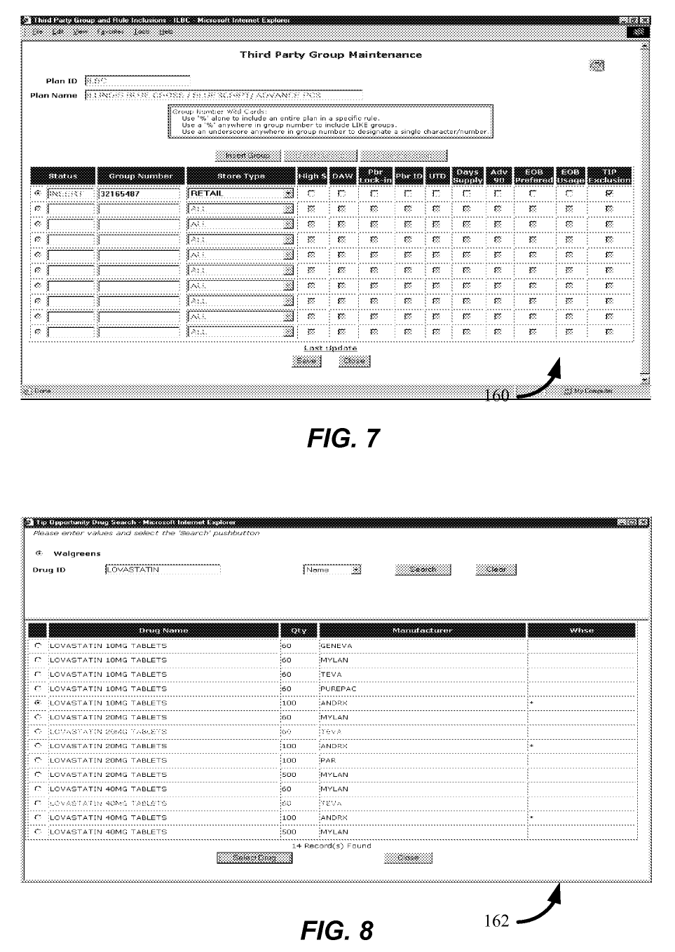

In yet another example, data for each of a plurality of groups (e.g., different medical insurance plans) may be maintained, and the group data may be updated to reflect the exclusion. Referring again to FIG. 3, a graphical representation button (“Group Maint”) is presented to the user, which the user can select to generate a display screen 160 shown in FIG. 7 which displays information on the group identified from the display screen 150. Generally, the display screen 160 is used to identify and track various pieces of information for a specific group (e.g., an identified medical insurance plan) and any associated sub-groups. In particular, the display screen 160 provides information on various aspects of the identified group (or sub-group) shown as columns of check boxes, including exclusions from the therapeutic interchange opportunities (“TIP Exclusion”). The user is further enabled to modify the aspects of the group (or sub-group), including adding or removing the exclusions by selecting or deselecting the appropriate check boxes. The display screen 160 also provides several fields from which the user may enter search criteria to search for a particular group, such as all insurance company or plan (e.g., Plan ID, Plan Name, etc.). The editor application 22 may perform a search of all groups to identify those that meet the provided search criteria the results of which are provided to the user to the lower half of the display screen 160.

In the above examples, it is generally assumed that each group of persons participating in a therapeutic interchange program would be offered replacement medications based on a common formulary for selecting replacement medications for a particular medication. However, in some instances, the formulary for selecting replacement medications may be based on third party formularies. For example, a particular medical insurance plan may have their own formulary for selecting replacement medications generally, or for a specific medication. As such, if a different replacement formulary is to be used in identifying replacement medications, the user may be presented with a graphical representation (“TIP Opportunity”) in the display screen 150 shown in FIG. 3 for identifying the new formulary.

Upon selecting the “TIP Opportunity” graphical representation, or its equivalent, the editor application 22 presents the user with a display screen 162 shown in FIG. 8 to search for a particular medication for which replacement medication will be identified using a third party formulary. The display screen 162 provides several fields from which the user may enter search criteria to search for a particular medication (e.g., Drug ID, etc.), and, more particularly, a particular medication for a specific third party (e.g. medical insurance plan). The editor application 22 may perform a search of all medications, or all medications under a particular group, such as a medical insurance plan identified in the display screen 150 of FIG. 3. The search results are provided to the user to the lower half of the display screen 162, from which the user may select the particular medication, for example by selecting the appropriate radio button associated with each search result.

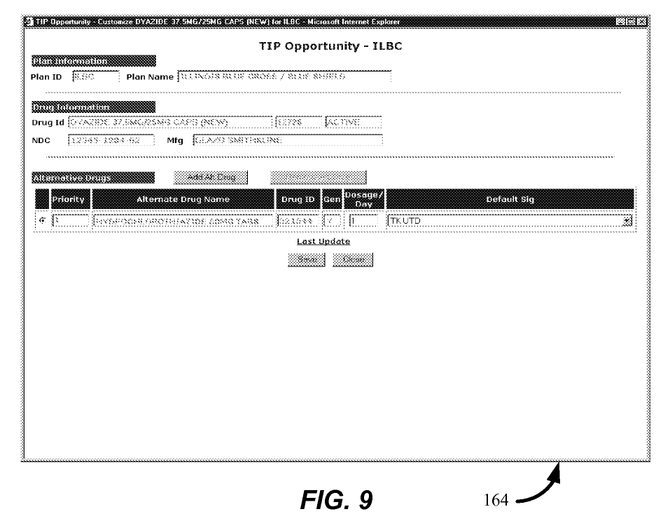

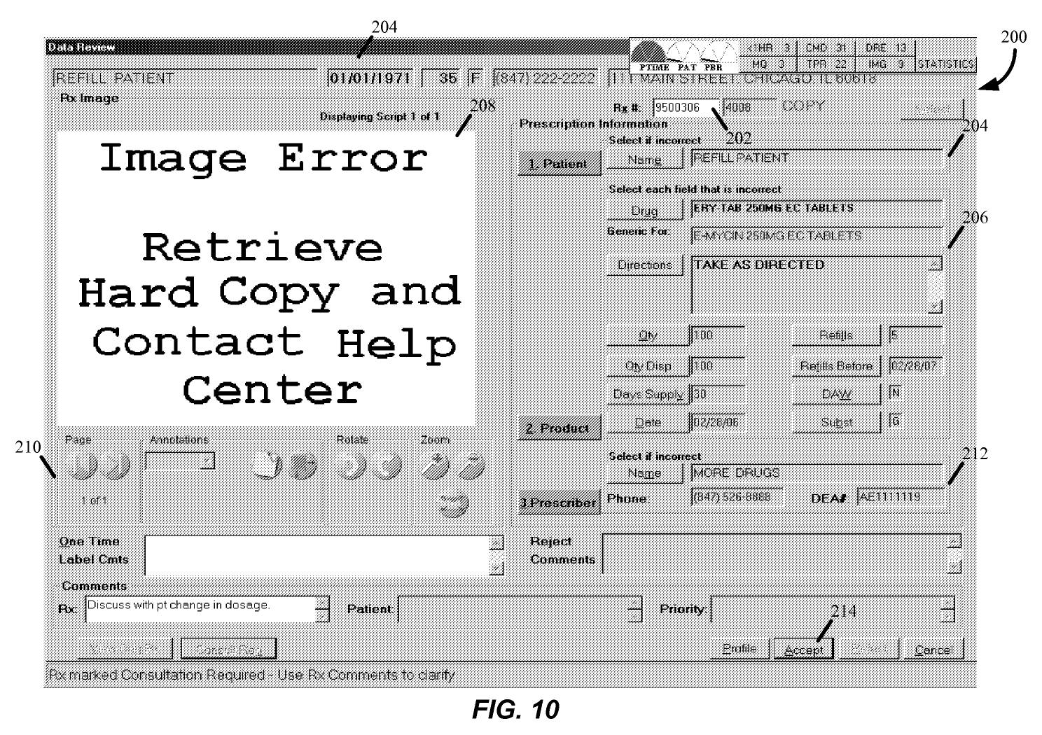

Once a medication has been selected from the search results of the display screen 162, the editor application 22 generates a display screen 164 shown FIG. 9. The display screen 164 is used to identify a unique therapeutically equivalent replacement medication specifically for the identified group (e.g., ILBC) and Hand medication (e.g. Dyazide. In particular, the replacement medication (e.g., hyrochlorothiazide) identified using the third-party formulary is displayed in the display screen 164. In one example, a replacement medication identified using a third-party formulary may override any previously identified replacement medications that are considered therapeutic equivalents, including those specified using the editor application 22 above. In a further example, a replacement medication identified using a third-party formulary may override a previously identified replacement medication for members belonging to an identified group (e.g. persons insured under the ILBC medical insurance plan).

As an alternative to using a third-party formulary to identify replacement medications different from those which may be identified by the user using the editor application 22, groups of persons may be excluded from being offered to replacement medication for a medication. In other words, groups of persons, for example under the same medical insurance plan, may still participate in being offered therapeutically equivalent replacement medications in general, but may be prevented from being offered therapeutically equivalent replacement medications for a particular medication. For example, referring to the display screen 164 of FIG. 9, the user may specify the replacement medication (i.e. Alternate Drug Name) to the original medication (e.g., specifying Lipitor 10 mg Tablets as the replacement medication for Lipitor 10 mg Tablets). As a result, even though a medication is defined as having a replacement medication, the user may prevent the medication from being substituted for a particular group people.

FIGS. 10-19 are exemplary graphical displays that man be provided by the GUI to enable a user at a workstation 12, such as a pharmacist or another qualified pharmaceutical professional, to be alerted to a replacement medication for a medication that is associated with a medication prescription being filled for a person. In particular, the graphical displays of FIGS. 10-19 may be utilized with respect to the therapeutic interchange application 24, though it should be readily understood that similar graphical displays may be used with respect to the therapeutic interchange application 24. For example, when a person contacts or is present at a pharmaceutical facility to fill a prescription prescribed by the person's medical provider, the user may initially be presented with a display screen to display information about the medication and the medication prescription, during which (or prior to which) the therapeutic interchange application 24 may identify any replacement medications associated with the medication being filled and alert the user if a replacement medication is available. Of course, the availability of the replacement medication may be dependent upon inclusions or exclusions defined during the editor application 22. If a replacement medication is available, the therapeutic interchange application 24 enables the user to review information regarding the replacement medication, offer the person an opportunity to exchange the prescribed medication for the replacement medication, generate a prescription for the replacement medication and obtain approval from the person's medical provider to exchange the prescribed medication for the replacement medication. As the therapeutic interchange application 24 is being executed, the choices made by the user may be saved as part of the replacement medication data in the data source 14 and/or as part of the medication prescription data in the data source 16 relating to the medication prescription for the person being offered the replacement medication.

As with the editor application 22, the displays of the therapeutic interchange application 24 include several graphical representations, each of which may represent a different option or command provided to the user by the therapeutic interchange application 24. Each of the graphical representations presented to the user in a display enable the user to select the associated option or command, for example, a keyboard, mouse, voice-response device, etc. Although several examples of graphical representations, such as buttons, data entries, etc., that may be selected by the user are described herein, it should be understood that each such graphical representation may be selected in a variety of manners using, for example, a keyboard, mouse, voice-response device, and the like and need not be repeated in each instance that a graphical representation is described.

FIG. 10 is an exemplary graphical display of a medication prescription data review screen 200 that may be provided by a graphical user interface to enable a user to provide information to a person when filling a medication prescription. In particular, the graphical display 200 provides the user with information pertaining to a medication prescription in the data source 16, and allows the user to access and modify various aspects of the medication prescription as needed. As shown in FIG. 10, the GUI may graphically depict a patient file, including, but not limited to, a scanned image of the original prescription for a medication, the original date of prescription, the medication name, instructions for administering the medication, including dosage, the cost of the medication, refills and refill dates, the prescriber of the medication and associated contact information.

In particular, the medication prescription data review screen 200 provides a prescription identifier view 202 which displays an identification of the medication prescription being reviewed, such as a prescription number, along with information about the person associated with the medication prescription in a patient information view 204. In particular, a user may identify the medication prescription to be reviewed, for example by entering the prescription identification number in the prescription identifier view 202 or by scanning a barcode of the medication prescription, in order to generate the medication prescription data in the medication prescription data review screen 200. In response thereto, the patient information view 204 may display information on such as the name, date of birth, age, gender, contact information of the person find the like. Details about the medication prescription are provided in a medication information view 206, including, but not limited to, the name of the medication, directions, supply/quantity information and prescription fill/refill information.

In addition to details about the medication prescription as shown in the medication prescription view 206, the medication prescription review screen 200 may also include an image 208 of the medication associated with the medication prescription or an image of the physical medication prescription as prescribed by a medical professional, such as the person's doctor. In particular, the image 208 may be a scanned image of the physical prescription written or otherwise provided by the person's medical provider. An image 208 of the medication and/or the original medication prescription may be used by the user to verify the information provided in the medication prescription view 206, and vice versa, to avoid mistakes in filling the medication prescription. The user may be provided with image controls, shown here as graphical representations 210, to manipulate the image as needed.

Details about the person prescribing the medication, such as a doctor or other medical professional, are provided in a prescriber information view 212, including the prescriber's name, contact information and professional identification. As a result, a user may contact the prescriber directly if any questions arise regarding the medication prescription during the review of the medication prescription data. The medication prescription data review screen 200 may further enable the user to modify any of the information provided in any of the views 202, or may restrict the user from modifying any of the information. The user may also be enabled to accept the information provided in each of the views 204, 206, 212, as well as provide his/her own comments regarding the review of the medication prescription.

As the user reviews and/or provides information related to the medication prescription, and selects the graphical representation 116 to accept or otherwise fill the medication prescription, the therapeutic interchange application 24 may retrieve replacement medication data from the data source 14 associated with the medication being filled according to the medication prescription. Although the above describes the therapeutic interchange application 24 as identifying replacement medications while the user reviews and/or provides information related to the medication prescription, it should be understood that the therapeutic interchange application 24 may operate separate from the GUI. For example, the therapeutic interchange application 24 may identify replacement medication as a separate application that continually monitors medication prescriptions as stored in the data sources 14, 16, identifies replacement medications as described further below, and stores the results in one or both of the data source 14, 16. When the user reviews and/or provides information related to the medication prescription, or selects the graphical representation 116 to accept or otherwise fill the medication prescription, the therapeutic interchange application 24 may retrieve the results from the data source 14 or 16 and notify the user as needed. As mentioned above, replacement medications may only be identified for particular medications. As such, if the therapeutic interchange application 24 is unable to find the medication associated with the medication prescription in the data source 14, or if the replacement medication data retrieved from the data source 14 indicates no replacement medication is available, the user will be permitted to continue filling the medication prescription according to the prescribed medication and complete a transaction for the prescribed medication.

On the other hand, if replacement medication data retrieved from the data source 14 indicates that a replacement medication is available for the prescribed medication, the user is alerted or otherwise prompted with a message that are replacement medication is available. For example, the therapeutic interchange application 24 may retrieve a data file associated with the prescribed medication and check the field within the data file to determine if a replacement medication has been entered as a predefined therapeutically equivalent alternative. If the data field has a value indicating that a replacement medication is available (e.g. the field has a value of “Y”) in the data source 14, the therapeutic interchange application 24 is executed following the display screen 200.

However, before alerting the user that a replacement medication is available, once the medication has been identified as having a therapeutically equivalent replacement medication, the therapeutic interchange application 24 determines whether the person may be offered the replacement medication. For example, as discussed above, a person may be excluded from being offered the replacement medication if the person is part of an excluded group, or if the person is part of a group that excludes a replacement medication for the medication being prescribed. As another example, the medication prescription data of the person may indicate that a previous opportunity to replace the prescribe medication with a replacement medication was refused (e.g. by the person and or the person's medical provider). The refusal may be read by the therapeutic interchange application 24, in which case the therapeutic interchange application 24 will not identify a replacement medication for the prescribed medication.

If the person is part of an included group (e.g., the person is covered by a medical insurance plan that is a participant in the therapeutic interchange program), the therapeutic interchange application 24 continues with identifying a replacement medication for the prescribed medication. For example, the therapeutic interchange application 24 may then determine whether the prescribe medication has a customized replacement medication associate of their with based on a third-party formulary. If so, therapeutic interchange application 24 identifies the replacement medication according to third-party formulary. Otherwise, the therapeutic interchange application 24 identities replacement medication according to the formulary utilized during the editor application 22.

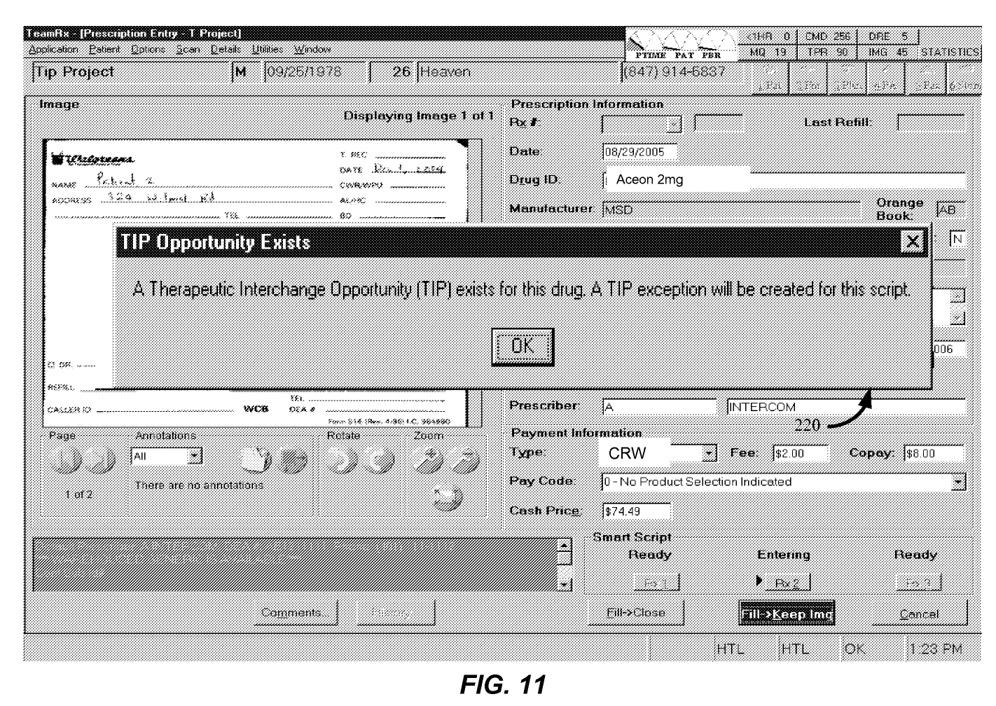

Regardless of whether the therapeutic interchange application 24 identifies replacement medication according to the general formulary utilized during the editor application 22 or according to a customized third-party formulary, the therapeutic interchange application 24 generates a prompt 220, or other suitable alert, shown in FIG. 11. Once the user acknowledges that a replacement medication is available, for example by selecting the “OK” graphical representation from the prompt 220, the therapeutic interchange application 24 generates an exception for the medication. In particular, the exception prevents medication from being dispensed to the person until the exception is resolved. The exception may be resolved by either rejecting the replacement medication or accepting the replacement medication, for example based on feedback from the person or the person's medical provider.

In generating the exception, the medication prescription is entered into an exception queue and is associated with an exception related to the availability of a replacement medication. Alternatively, the medication prescription data within the data source 16 may be updated with an indication that an exception is associated with the medication prescription based on the availability of a replacement medication. In one example, if the exception is not resolved within a predetermined amount of time, the exception may be automatically removed and the user may be permitted to fill the medication prescription based on the prescribed medication.

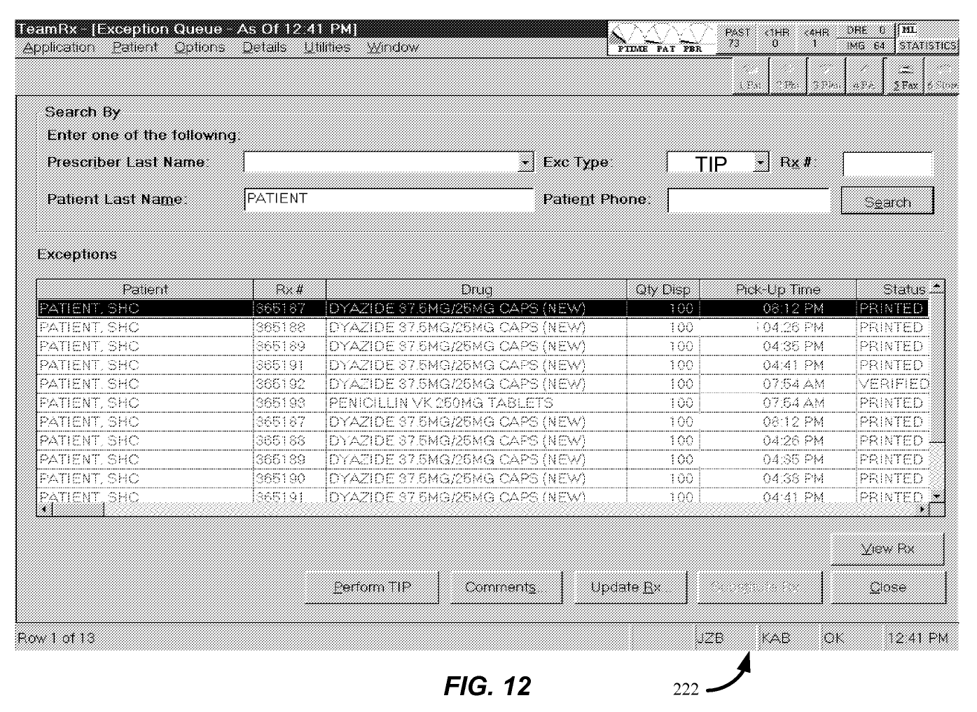

In response to acknowledging that a replacement medication is available following the prompt 220, the therapeutic interchange application 24 may generate a display screen 222 showing the current exception queue. For example, as seen in FIG. 12, the display screen 222 showing the exception queue may automatically display the replacement medication exception associated with the medication prescription from the display screen 200. The display screen 222 may further provide several fields from which the user may enter search criteria to search for exceptions associated with the person and/or the person's medication Prescription (e.g., Prescriber Last Name, Patient Last Name, Patient Phone, Exception Type, etc.). For example, replacement medication exceptions may be displayed by selecting the replacement medication execution type (e.g., “TIP”), entering an identification of the medication prescription that has the replacement medication exception, searching for the person's name, etc. The therapeutic interchange application 24 may perform a search of all exceptions to identify those that match the provided search criteria, the results of which are provided to the user. The list of exceptions in the display screen 222 are provided as user selectable items, which enables the user to select the exception associated with the replacement medication for the medication prescription.

As indicated above, and as discussed further below, the replacement medication exception may be resolved by accepting or denying the replacement medication. As such, the display screen 222 for the exception queue may be provided with a variety of options that may be selected by the user to resolve the replacement medication exception, such as removing the exception, performing the interchange, accepting or denying the interchange opportunity based on feedback from the person's medical provider and reversing a previously executed interchange of the original medication for the replacement medication.

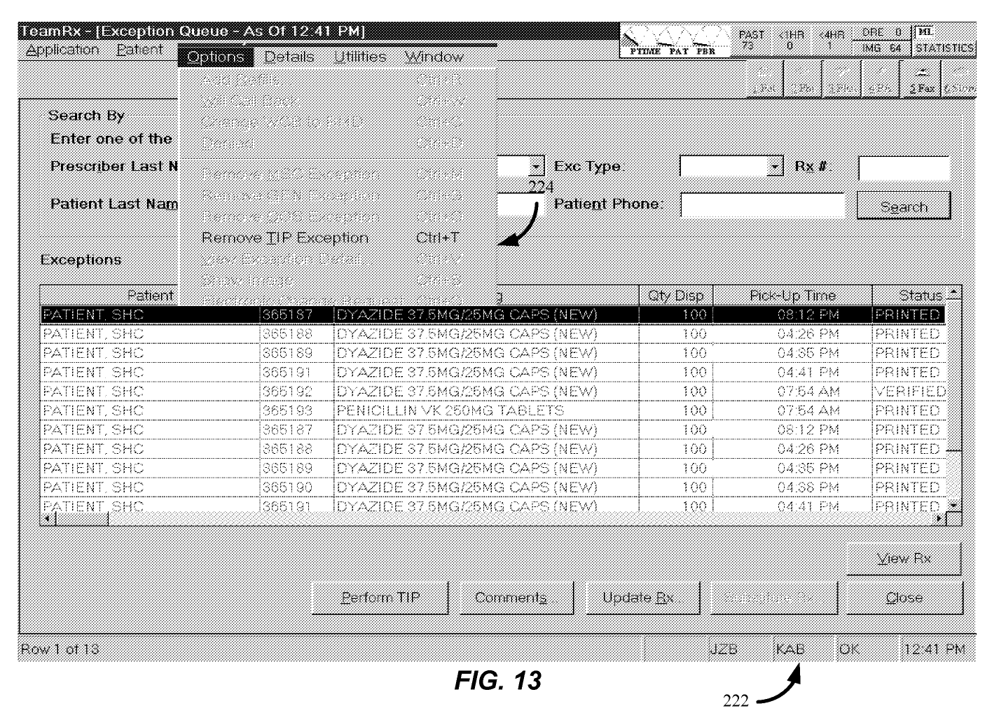

Referring to FIG. 13, the user may remove the replacement medication exception by selecting the appropriate option from a drop-down menu 224 (e.g., “Removed TIP Exception”). For example, just as the user may be notified of an opportunity to exchange the original medication for the replacement medication, the user may notify the person of the same. In some instances, the person may not want to replace the prescribed medication, in which case the user may select the option to remove the exception based on the person's response before the interchange has occurred. If the user selects the option to remove the exception, the therapeutic, interchange application 24 disassociates the exception from the medication prescription, for example by updating the medication prescription information in the data source 16. The therapeutic interchange application may further update the display screen 222 to inform the user that the exception is being removed, and displays a message once the removal is complete. Thereafter, the therapeutic interchange application 24 allows the user to continue filling the medication prescription based on the original medication and complete the transaction thereof. Data relating to the disassociation of the replacement medication exception and the medication prescription is tracked by the therapeutic interchange application 24 and stored as part of the persons medication prescription data in the data source 16. Thereafter, if the person refills the medication for the medication prescription, the therapeutic interchange application 24 will read that a previous opportunity to exchange the prescribe medication for the replacement medication was refused by the person and will not prompt the user that a replacement medication exists.

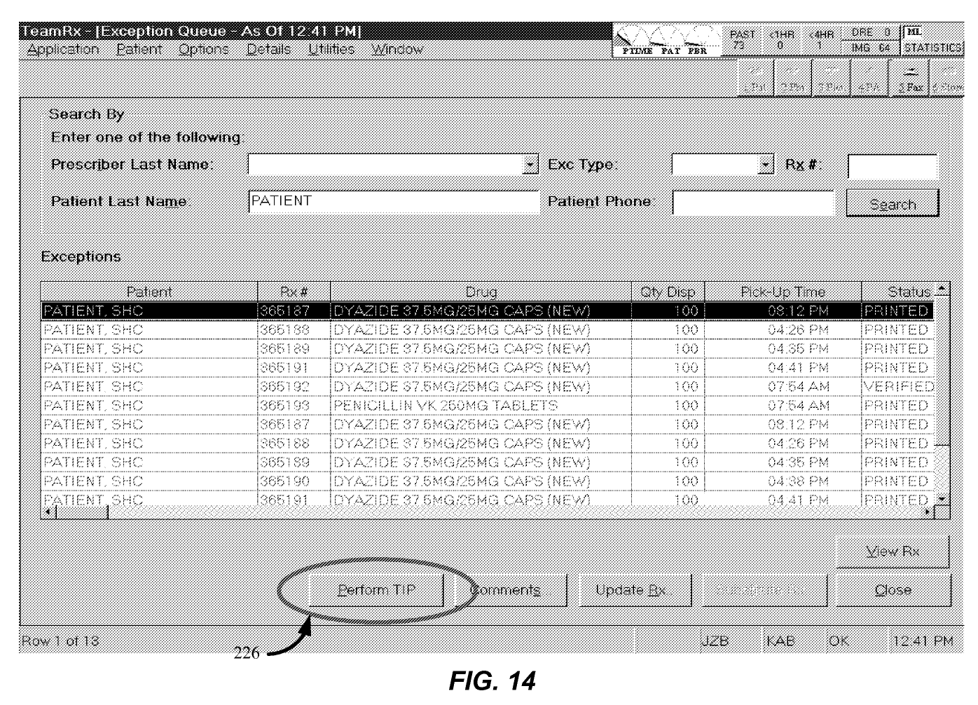

On the other hand, if the person accepts the replacement medication, or otherwise has not refused the interchange, the user may proceed with the interchange by selecting the replacement education exception associated with the prescribed medication, and selecting the graphical representation 226 to perform the interchange (“Perform TIP”) as shown in FIG. 14. Upon selecting the graphical representation to perform the interchange, the therapeutic interchange application 24 may prevent the medication from being dispensed to the person until the exception is further result. The therapeutic interchange application 24 may further provide a therapeutic interchange display of information on the prescribed medication and information on the identified replacement medication.

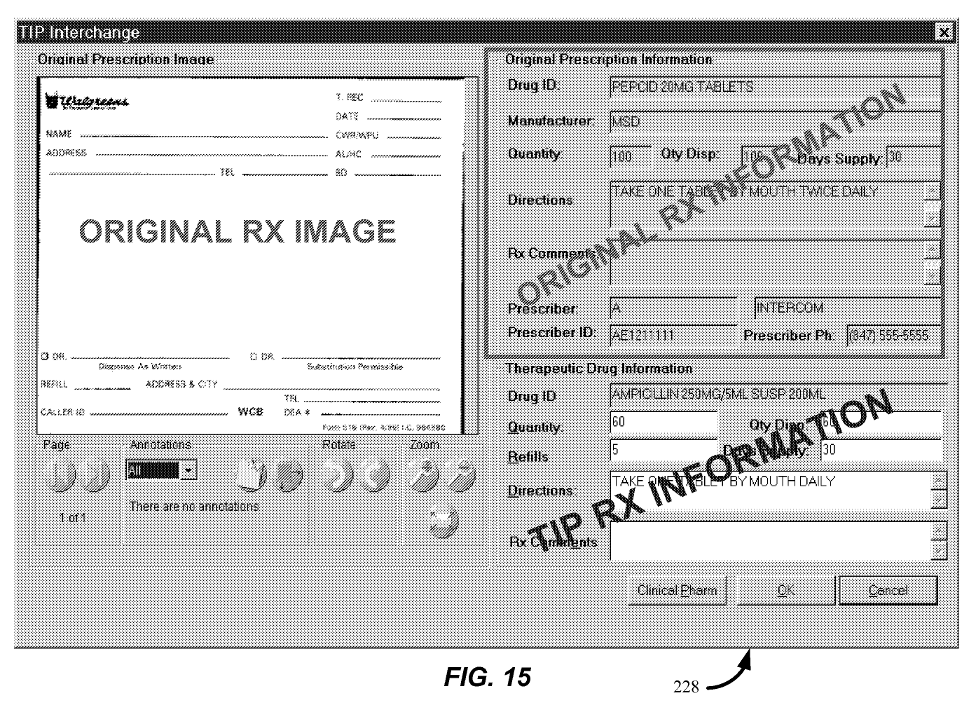

FIG. 15 is exemplary graphical display of a therapeutic interchange display 228 that may be provided by the GUI to enable a user to view information associated with the replacement medication and the prescribed medication. The prescribed medication information may be retrieved from the data source 16 and displayed to the user, and the replacement medication information may be retrieved from the data source 14 and likewise displayed to the user. The information for the prescribed medication may include, but is not limited to, the original scanned prescription, the name, quantity, administration instructions and comments for the original and new medications. The prescribed medication information may further include the prescriber of the prescribed medication (e.g., the person's medical provider) and associated contact information. The replacement medication information may include the name of the replacement medication, as well as amounts relating to quantity, number of refills, directions, associated comments, etc.

While the name of the replacement medication and the information for the prescribed medication may not be changed, the remaining fields for the replacement medication may be editable such that the user may change the quantity, number of refills, administrations instructions and comments relating to the replacement medication. In one example, the fields relating to the quantity, number of refills, instructions, comments, etc. may be pre-populated based on default values determined when identifying replacement medications for the medication associated with the medication prescription. However, the therapeutic interchange application 24 may enable the user to user may modify these values as needed. For instance the user may be provided with a graphical representation (“Clinical Pharm”) to provide a link to determine the guidelines for dosage and directions for the replacement medication.

The display screen 228 may further include a graphical representation that allows the user to accept (“OK”) or deny (“Cancel”) the therapeutic interchange. If the user chooses to deny the therapeutic interchange, for example based on a change of opinion by the person, the user is returned to the display screen 222 of the exception queue to resolve the exception. Otherwise cause the user chooses to accept the therapeutic interchange, the therapeutic interchange application 24 may generate a proposed medication prescription for the replacement medication.

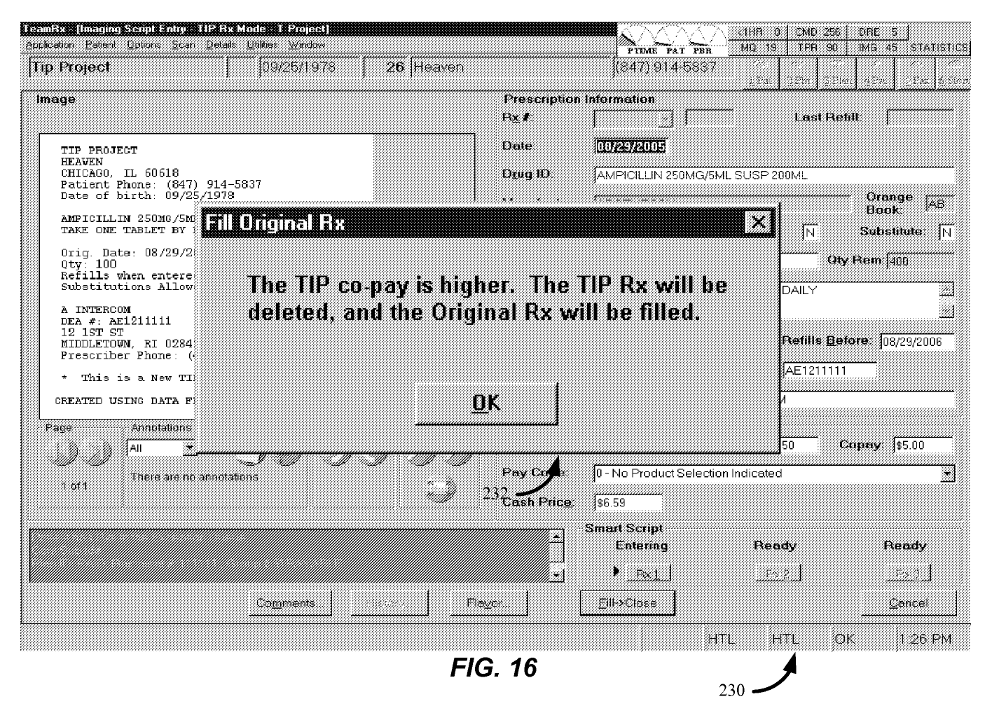

FIG. 16 is exemplary graphical display 230 of the proposed medication prescription for the replacement medication that may be provided by the GUI to the user to display the proposed medication prescription. As shown in FIG. 16, the replacement medication data review screen 230 is pre-populated with information on the replacement medication in a manner similar to that of the display screen 200 shown in FIG. 10 for the prescribed medication. For example, the medication prescription data review screen 230 provides an identifier view which displays an identification of the replacement medication being reviewed, such as a prescription number, along with information about the person associated with the medication prescription in a patient information view. As with the display screen 200, the patient information view may display information such as the name, date of birth, age, gender, contact information of the person and the like. Details about the replacement medication are provided in a medication information view, including, but not limited to, the name of the replacement medication, directions, supply/quantity information and prescription fill/refill information.

In addition to details about the replacement medication as shown in the medication prescription view, the replacement medication review screen 230 may also include an image generated by the therapeutic interchange application 24 of the proposed medication prescription for the replacement medication. In contrast to a scanned image of the medication prescription provided with the display screen 200, the image of the proposed medication prescription is a mockup generated by the therapeutic interchange application 24 based on the replace a meditation data from the data source 14. However, the mockup image of the proposed medication prescription may be used by the user to verify the information provided in the medication prescription view, and vice versa, to avoid mistakes in proposing the medication prescription for the replacement medication.

Details about the person medical provider, such as a doctor or other medical professional, are provided in a prescriber information view, including the name, contact information and professional identification. As discussed further below, the interchange of the prescribe medication for the replacement medication is generally performed only with the approval of the person's medical provider, it generally the same person who originally prescribed to the medication for the person. As such, the therapeutic interchange application 24 enables the user to contact the medical provider via the medical provider's workstation 20, or other suitable communication method. Upon selecting a graphical representation to fill or otherwise accept the proposed medication prescription (“Fill->Close”), a request to replace the prescribe medication with the replacement medication is transmitted to the medical provider. The request further includes data relating to the prescribe medication as well as data relating to the replacement medication. Thereafter, based on a response from the medical provider, the replacement medication exception is resolved.

However, prior to transmitting the request to the medical provider, the therapeutic interchange application 24 may conduct a cost comparison between the prescribed medication and the replacement medication. In particular, if the cost to the person for the replacement medication is higher than that of the prescribe medication, either based on overall costs of the medication or based on co-pays incurred by the person taking into account insurance coverage, the user may be alerted that is the cost is higher and the therapeutic interchange application 24 may terminate the interchange of the prescribed medication for the replacement medication. For example, as shown in FIG. 16, a pop-up box is generated 232 indicating the medication costs between the original prescription and the new medication have been compared, as well as the results of the comparison and the resulting course of action. Upon acknowledging the higher cost of the replacement medication, for example by selecting the graphical representation “OK”, the display screen 230 may be closed, and the therapeutic interchange application 24 may return the user to the display screen 222 showing the exception queue. The therapeutic interchange application 24 may further resolve the exception automatically by removing the exception and allowing the user to fill the dedication prescription based on the prescribed medication.

On the other hand, if the cost to the person for is the replacement medication is equal to or lower than that of the prescribed medication, the request is sent to the medical provider to approve or deny the proposed medication prescription for the replacement medication. As indicated above, the request to the medical provider may include information about the prescribed medication and replacement medication, including identification of the medications, dosage, reasons for the proposed interchange, etc. further, the request of medical provider may include information about the person, including medical history, reasons for the prescribed medication etc. to allow the medical provider to more readily ascertain whether the replacement medication should be provided to the person. Thereafter, the therapeutic interchange application 24 waits for response from the medical provider, which may be provided via the user as discussed further below.

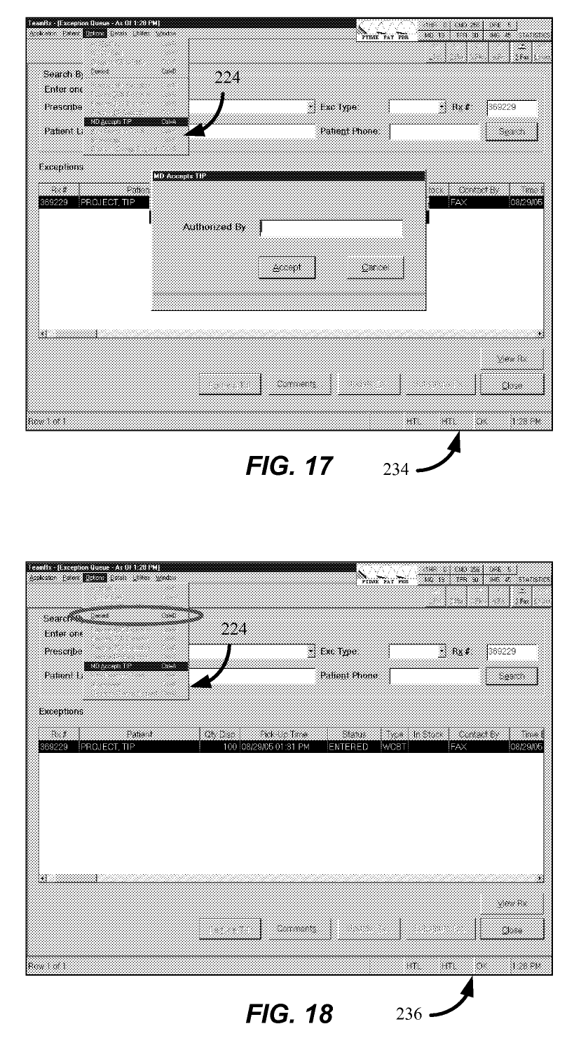

FIGS. 17 and 18 are exemplary graphical displays that may be provided by the GUI to enable a user to accept or deny the proposed medication prescription for the replacement medication based on the medical provider's response regarding the proposed medication prescription for the replacement medication. In particular, if the medical provider approves of the change, the graphical display 234 of FIG. 17 may be generated with a pop-up box requesting data on the name of the medical provider authorizing the change. Accordingly, the replacement medication is prescribed, a refill of the original medication is blocked wheel the patient attempts a refill, and the patient is consulted regarding the change. In particular, user may be provided with the display screen 224 of FIG. 13 with the replacement medication exception automatically selected.

As indicated above, and as discussed further below, the replacement medication exception may be resolved by accepting or denying the replacement medication. For example, the display screen for the exception queue may be provided with a variety of options that may be selected by the user to resolve the replacement medication exception. One of the options may include a graphical representation to accept the interchange opportunity based on the response from the person's medical provider. Accordingly, the user may select the graphical representation to accept the interchange from the drop-down menu 224, and the therapeutic interchange application 24 removes the replacement medication exception from the medication prescription. Thereafter, therapeutic interchange application 24 may update the medication prescription data in the data source 16 by replacing data relating to the prescribed medication with data relating to the replacement medication. Alternatively, the therapeutic interchange application 24 may delete the medication prescription for the prescribed medication and substitute the proposed medication prescription for the replacement medication in its place. Thereafter, any subsequent fills her refills for the medication prescription will be done on the basis of the replacement medication. The therapeutic interchange application 24 may further update to the medication prescription data to indicate that a therapeutic interchange has been performed such that subsequent fills or refills for the replacement medication will not generate alerts for further replacement medications.

On the other hand, if the medical provider rejects the proposed medication prescription, the display screen 236 of FIG. 18 may be generated and the user may indicate that the request was denied via the drop-down menu 224. Accordingly, the therapeutic interchange application 24 removes the replacement medication exception from the medication prescription, and the user is permitted to complete filling the prescribed medication and complete a transaction for the prescribed medication. The therapeutic interchange application 24 further updates the medication prescription data to indicate that a therapeutic interchange has been rejected such that subsequent fills or refills of the prescribe medication will not generate an alert for a replacement medication.

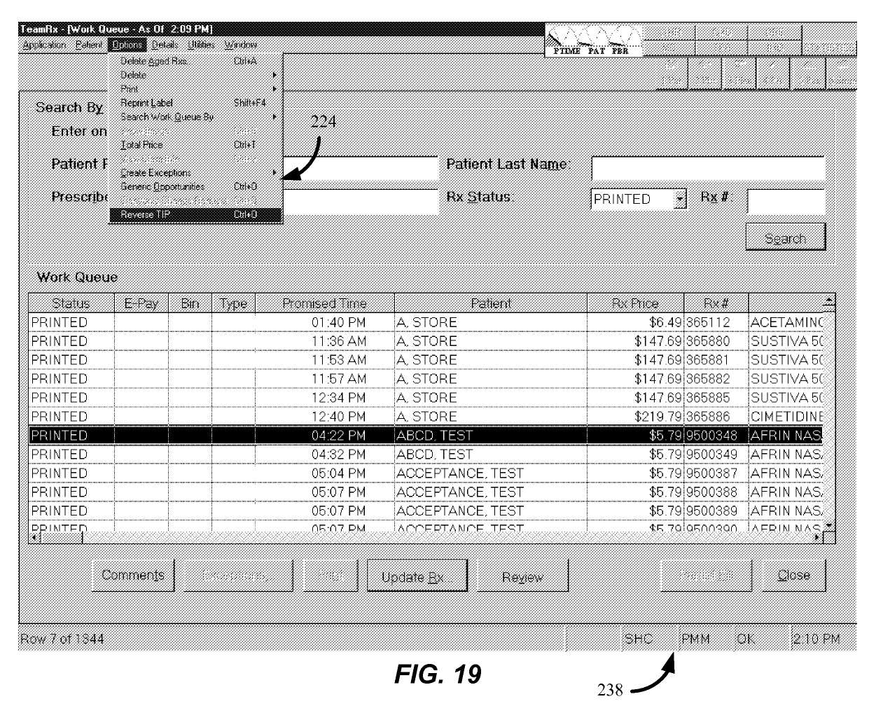

A further option presented to the user from the display screen 222 is an option to reverse a previously performed therapeutic interchange, as shown in the display screen 238 of FIG. 19. For example, a versus medical provider proves of the therapeutic interchange, the person may subsequently rejected the replacement medication and request the prescribe medication to refill. Accordingly, the user may select the graphical representation to reverse the therapeutic interchange (“Reverse TIP”) from the drop-down menu 224. In response thereto, the therapeutic interchange application 24 may generate a message to the user indicating the replacement medication, and any proposed medication prescription associate at their with will be deleted and the medication prescription for the prescribed medication will be processed. The therapeutic interchange application 24 may update the medication prescription data to indicate that a therapeutic interchange has been rejected, and subsequent fills or refills of the prescribe medication will not generate an alert for a replacement medication. The therapeutic interchange application may further notified the medical provider of the reversal. However, in one example, the option to reverse the therapeutic interchange may be disabled upon completing the transaction for the replacement medication.

Although the therapeutic interchange editor application and therapeutic interchange application and various methods associated therewith, as described herein, are implemented in software, it may be implemented in hardware, firmware, etc., and may be implemented by any other processor associated with the store and other facilities. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and systems described herein are illustrative only and are not limiting upon the scope of the claims.

What is claimed is:

1. A method of medication prescription interchange comprising:
receiving medication prescription data relating to a medication prescription for a person, wherein the medication prescription data comprises data related to a medication associated with the medication prescription;
identifying a replacement medication for the medication associated with the medication prescription, wherein the replacement medication comprises a therapeutic equivalent to the medication for the person and identifying the replacement medication associates the replacement medication with the medication prescription data;
generating an exception for the medication if a replacement medication is identified, wherein the exception prevents the medication from being dispensed to the person until the exception is resolved;
transmitting a request to replace the medication associated with the medication prescription with the replacement medication to a medical provider associated with the person along with the data relating to the medication and data relating to the replacement medication;
receiving a response from the medical provider, wherein the response comprises an acceptance or denial of the request; and
resolving the exception based on the response from the medical provider.

2. The method of claim 1, further comprising updating the medication prescription data with the data relating to the replacement medication if the response from the medical provider comprises an acceptance of the request.

3. The method of claim 2, further comprising:
receiving an indication comprising an acceptance of denial of the replacement medication by the person; and
updating the medication prescription data with the data relating to the medication if the person rejects the replacement medication.

4. The method of claim 1, further comprising disassociating the replacement medication from the medication prescription data and removing the exception associated with the medication prescription data if the response from the medical provider comprises an denial of the request.

5. The method of claim 1, wherein identifying a replacement medication comprises determining a replacement medication having a lower cost than the medication associated with the medication prescription.

6. The method of claim 1, wherein identifying a replacement medication comprises determining a replacement medication to reduce a side effect associated with the medication associated with the medication prescription.

7. The method of claim 1, wherein identifying a replacement medication comprises determining a replacement medication having a medical effect equivalent to the medication associated with the medication prescription.

8. The method of claim 1, wherein identifying a replacement medication comprises determining a replacement medication having an improved medical effect as compared to the medication associated with the medication prescription.

9. The method of claim 1, wherein identifying a replacement medication comprises determining a replacement medication to improve the combined medical effect of the medication associated with the medication prescription and a medication associated with another medication prescription for the person.

10. The method of claim 1, wherein identifying, a replacement medication comprises:
searching a database for medication replacement data related to the medication, wherein the medication replacement data comprises one or more replacement medications for the medication; and
returning one of the one or more replacement medications as the identified replacement medication.

11. The method of claim 10, wherein returning one of the one or more replacement medications as the identified replacement medication comprises returning a medication identified as a default replacement medication from the one or more replacement medications.

12. The method of claim 1, further comprising:
comparing a cost of the medication with a cost of the replacement medication; and
preventing the exception from being generated if the cost of the replacement medication exceeds the cost of the medication.

13. The method of claim 1, wherein the medication prescription data compromises history data related to a history of the medication prescription including a previous resolution of an exception related to a replacement medication for the medication associated with the medication prescription, the method further comprising preventing the exception from being generated if the previous resolution comprised rejecting the replacement medication.

14. A pharmaceutical interchange system for use in a pharmaceutical facility comprising:
a medication prescription database adapted to store data comprising one or more medication prescription data entries each relating to a medication prescription and medication data related to a medication associated with the medication prescription;
a replacement medication database adapted to store data comprising one or more medication data entries each relating to a medication and at least one therapeutic equivalent replacement medication for the medication; and
a display application stored on a computer readable memory and adapted to be executed on a processor to create a medication interchange display and to create a replacement medication prescription review display, the medication interchange display including a medication information view having information relating to a medication prescription for a person from the data stored in the medication prescription database, a replacement medication information view having information relating to a replacement medication for the medication associated with the medication prescription for the person from the data stored in the replacement medication database and a graphical representation relating to a replacement of the medication with the replacement medication, wherein the display application enables a user to select the graphical representation relating to the replacement of the medication to generate the replacement medication prescription review display, the replacement medication prescription review display having information relating to a medication prescription for the person based on the replacement medication and a graphical representation of a request to replace the medication with the replacement medication, wherein the display application enables the user to select the graphical representation of the request to generate a request to replace the medication with the replacement medication to a medical provider associated with the person.

15. The pharmaceutical interchange system of claim 14, wherein each replacement medication in the medication data entries the replacement medication database comprises a more efficient medication as compared to the related medication and a therapeutic effect at least equivalent to the related mediation.

16. The pharmaceutical interchange system of claim 14, wherein the display application enables the user to select the graphical representation of the request to transmit the data relating to the replacement medication and the data relating to the medication to the medical provider.

17. The pharmaceutical interchange system of claim 14, wherein the display application is adapted to be executed on a processor to create an exception queue display including a search view having one or more data entries to input search criteria, a results view, and a graphical representation relating to a therapeutic interchange, wherein the display application enables the user to provide search criteria via the one or more data entries in the search view.

18. The pharmaceutical consultation system of claim 17, wherein the search criteria comprises one or more of the group consisting of: an identification of a medication prescription and an identification of a person, wherein the display application presents one or more medication prescription exception entries having attributes matching the search criteria in the results view and enables the user to select different ones of the one or more medication prescription exception entries presented in the results view, wherein at least one of the medication prescription exception entries comprises a medication prescription exception entry relating to replacement of the medication with the replacement medication.

19. The pharmaceutical consultation system of claim 18, wherein the display application enables the user to select the graphical representation relating to the therapeutic interchange to generate the medication interchange display based on a selected one of the medication prescription exception entries relating to replacement of the medication with the replacement medication.

20. The pharmaceutical consultation system of claim 18, wherein the display application is adapted to be executed on a processor to create a medication prescription review screen having information relating to the medication prescription and a graphical representation relating to dispensation of the medication prescription, wherein the display application enables the user to select the graphical representation relating to dispensation of the medication prescription to generate the exception queue display.

21. The pharmaceutical consultation system of claim 18, wherein the display application is adapted to be executed on a processor to create a medication prescription review screen having information relating to the medication prescription and a graphical representation relating to dispensation of the medication prescription, wherein the display application enables the user to select the graphical representation relating to dispensation of the medication prescription which generates a display prompt to the user indicating a replacement medication for the medication exists based on the data stored in the replacement medication database.

22. The pharmaceutical consultation system of claim 21, wherein the display prompt comprises a graphical representation relating to acknowledgement of the prompt, wherein the display application enable the user to select the graphical representation relating to an acknowledgement to generate the exception queue display.

23. The pharmaceutical interchange system of claim 18, wherein the exception queue display comprises a graphical representation relating to a denial of the request and a graphical representation relating to an acceptance of the request, wherein the display application enables the user to select the graphical representation relating to the acceptance or the request to generate the exception queue display, and enables the user to remove the medication prescription exception entry relating to the replacement of the medication with the replacement medication and update the medication prescription data with data relating to the replacement medication.

24. The pharmaceutical interchange system of claim 23, wherein the exception queue display comprises a graphical representation relating to a reversion of the replacement, wherein the display application enables a user to select the graphical representation relating to the reversion to update the medication prescription data with data relating to the medication after the medication prescription data has been updated with data relating to the replacement medication.

25. The pharmaceutical interchange system of claim 23, wherein the display application enables a user to select the graphical representation relating to the denial of the request to remove the medication prescription exception entry relating to the replacement of the medication with the replacement medication and update the medication prescription data with data relating to a denial of the replacement medication.

26. The pharmaceutical interchange system of claim 14, wherein the display application is adapted to be executed on a processor to create a medication substitution information display having a medication information view having information relating to a medication and a replacement medication information view having one or more entries each relating to a replacement medication for the medication in the medication information view, wherein the display application enables the user to select different ones of the one or more replacement medication entries presented in the replacement medication information to store replacement medication data related to the selected one of the replacement medications entries with data related to the medication as a medication data entry in the replacement medication database.

27. A method of medication prescription interchange comprising:
receiving medication prescription data relating to a first medication prescription for a person, wherein the medication prescription data comprises data related to a first medication associated with the first medication prescription;
searching for a second medication associated with the first medication;
displaying an alert to a user if a second medication is associated with the first medication;
displaying a medication interchange display having information relating to the first and second medications;
generating a second medication prescription for the second medication associated with the second medication prescription;
enabling the user to submit the first and second medication prescriptions with a request to a medical provider to approve the second medication prescription; and
completing a transaction for the first or second medication prescription based on a response to the request from the medical provider.

28. The method of claim 27, further comprising:
displaying a medication prescription review display having information relating to the first medication prescription and an image of the first medication prescription, wherein receiving medication prescription data relating to the first medication prescription comprises enabling the user to provide the information relating to the first medication prescription in the medication prescription review display; and
enabling the user to complete a transaction for the first medication prescription, wherein searching for a second medication associated with the first medication is performed in response to the user attempting to complete the transaction for the first medication.

29. The method of claim 27, wherein searching for a second medication associated with the first medication comprises searching for a second medication having a lower cost than the first medication.

30. The method of claim 29, wherein searching for a second medication having a lower cost than the first medication comprises:
comparing a cost of the first medication with a cost of the second medication; and
preventing the alert from being displayed if the cost of the second medication exceeds the cost of the first medication

31. The method of claim 27, wherein searching for a second medication associated with the first medication comprises searching for a second medication to reduce a side effect associated with the first medication.

32. The method of claim 27, wherein searching for a second medication associated with the first medication comprises searching for a second medication having a medical effect equivalent to the first medication.

33. The method of claim 27, wherein searching for a second medication associated with the first medication comprises searching for a second medication having an improved medical effect as compared to the first medication.

34. The method of claim 27, wherein searching for a second medication associated with the first medication comprises searching for a second medication to improve the combined medical effect of the first medication and a third medication associated with a third medication prescription for the person.

35. The method of claim 27, further comprising:
generating a replacement exception for the first medication prescription if a second medication is associated with the first medication;
displaying an exception queue display having information relating to one or more exceptions associated with first medication prescription including the replacement exception;
enabling the user to disassociate the exception from the first medication prescription and complete a transaction for the first medication prescription;
enabling the user to exchange the first medication for the second medication; and
displaying the medication interchange display having information relating to the first and second medications in response to the user attempting to exchange the first medication for the second medication.

36. The method of claim 27, wherein displaying a medication interchange display having information relating to the first and second medications comprises enabling the user to edit the information relating to the second medication in the medication interchange display.

37. The method of claim 27 further comprising:
displaying a replacement medication prescription review display having information relating to the second medication prescription and an image of the second medication prescription;
enabling the user to provide information relating to the second medication prescription in the replacement medication prescription review display; and
enabling the user to complete a transaction for the second medication prescription.

38. The method of claim 37, wherein enabling the user to complete a transaction for the second medication prescription comprises displaying an exception queue display having information relating to one or more exceptions associated with first medication prescription including the replacement exception;
enabling the user to disassociate the exception from the first medication prescription and complete a transaction for the first medication prescription;
enabling the user to update the medication prescription data relating to the first medication prescription with data relating to the second medication prescription and complete a transaction for the second medication prescription.

39. The method of claim 37, further comprising enabling the user to update the medication prescription data relating to the second medication prescription with data relating to the first medication prescription and complete a transaction for the first medication prescription.

40. The method of claim 37, wherein enabling the user to complete a transaction for the second medication prescription comprises enabling the user to complete a transaction for the second medication prescription based on the response to the request from the medical provider.
